(19) United States
(12) Patent Application Publication
(10) Pub. No.: US 2012/0102089 A1
(43) Pub. Date: Apr. 26, 2012

(54) Server and Process for Producing an IP Application Exchange Data Set

(75) Inventor: Thomas Haines, East Perth (AU)

(73) Assignee: PRACTICE INSIGHT PTY LTD, East Perth (AU)

(21) Appl. No.: 12/911,469

(22) Filed: Oct. 25, 2010

(30) Foreign Application Priority Data
Oct. 22, 2010 (AU) 2010235965

(51) Int. Cl. G06F 15/16

(52) U.S. Cl. 709/203

(57) ABSTRACT

A process for producing an IP application exchange data set for a given party in relation to a jurisdiction using a database containing records of destination IP applications and records of source IP applications. Each destination IP application is associated with a source IP and each record identifies the party that filed the IP application and jurisdiction in which the IP application was filed. A data set generation module generates an IP application exchange data set for a given party in relation to a jurisdiction. The case exchange data set contains two lists of parties. The first list consists of parties that have filed at least one destination IP application in the jurisdiction for which the associated source IP application was filed by the given party. The second list consists of parties that have filed at least one source IP application in the jurisdiction for which an associated destination IP application was filed by the given party. The data set generation module is adapted to produce the total number of IP applications filed by each party in the first and second lists. An output module is provided to send the case exchange data set to a recipient via a data communications network.

### FIELD OF THE INVENTION

The present invention relates to a server and process for producing an IP application exchange data set.

A reference herein to “IP” means “intellectual property”.

A reference herein to “IP” includes each type of IP that may be applied for, by at least one applicant, to an administrative body. By way of example only, three types of such IP include patents, trade marks and designs.

A reference herein to an “administrative body” includes a reference to a server of an administrative body and any agent or facility, or server of any agent or facility, able to receive requests for, or on behalf of, an administrative body. By way of example only, a patent office, trade mark office or IP office of a country, or group of countries, is an administrative body.

Throughout the specification unless the context requires otherwise, the word “comprise” or variations such as “comprises” or “comprising”, will be understood to imply the inclusion of a stated integer or group of integers but not the exclusion of any other integer or group of integers.

Throughout the specification unless the context requires otherwise, the word “include” or variations such as “includes” or “including”, will be understood to imply the inclusion of a stated integer or group of integers but not the exclusion of any other integer or group of integers.

### BACKGROUND ART

The discussion of the background art, any reference to a document and any reference to information that is known, which is contained in this specification, is provided only for the purpose of facilitating an understanding of the background art to the present invention, and is not an acknowledgement or admission that any of that material forms part of the common general knowledge as at the priority date of the application in relation to which this specification has been filed.

Most countries have regimes for the protection of IP. To obtain protection for some types of IP, the owner or some other permitted party must file an application with the appropriate IP office that administers the IP regime for the country, or countries, in which the IP protection is required. After such an application has been filed with an IP office, it undergoes processing in accordance with the relevant requirements in that country for the particular type of IP in respect of which the application has been filed. Examples of such IP types include patents, trade marks and designs.

Often, an applicant requires that such an IP application is filed in not only the applicant's home country, but also requires that corresponding applications are filed in one of more other countries in which the applicant would like to obtain protection for the IP. The filing of such corresponding applications in other countries is generally organised by an attorney firm (“home attorney firm”) which the applicant has instructed in the applicant's home country. The home attorney firm instructs other attorney firms in relevant countries to file the corresponding applications as required by the applicant. For example, the applicant's home country may be the USA and the applicant's US attorney firm, i.e. the home attorney firm, has already filed a US patent application with the US Patent and Trademark Office for the applicant. The applicant may then instruct their US attorney firm that they require corresponding patent applications to be filed in Europe, Canada and Australia. The applicant's US attorney firm would then prepare and send instructions to other attorney firms in Europe, Canada and Australia to file the corresponding patent applications with the European, Canadian and Australian Patent Offices.

The home attorney firm in the applicant's home country may use various criteria to decide on which attorney firms to instruct to file the corresponding IP applications in the other countries required by the applicant. Such criteria may include fees, expertise, existing relationships, and reciprocity prospects. Usually, the home attorney firm readily is able to make an informed determination under the criteria of fees, expertise and relationships. For example, the home attorney firm is able to contact several attorney firms in a particular country and obtain and compare their respective fees for filing the corresponding IP application in that particular country; the home attorney firm is also able to obtain information (e.g. from attorney firms' websites and professional associations) on the expertise and specialities of several attorney firms in a particular country to determine which one would be the most appropriate to instruct; and, the home attorney firm is aware of the attorney firms in the other countries with which the home attorney firm already has an existing relationship, so that such attorney firms may be preferred firms for the home attorney firm to instruct.

By contrast, making an informed determination based on reciprocity prospects is not as readily achievable. Under this criterion, the home attorney firm tries to identify attorney firms in the other countries that are good prospects for reciprocity, i.e. that are likely to be in a position to send the home attorney firm IP applications to file in the home attorney firm's home country in return for the IP applications that the home attorney firm sends to them to file in the other countries. The home attorney firm may try to identify such attorney firms based on the apparent size of the attorney firm (e.g. the number of staff that they have), the number of IP applications that they have filed in their country, and/or the actual applicants for whom they have filed IP applications. However, identifying attorney firms in other countries in this manner is not a reliable way to identify attorney firms in other countries that may be good reciprocity prospects for the home attorney firm. For example, the size of an attorney firm and the number of IP applications they file in their home country is not indicative of that firm's ability or likelihood to send IP applications to the home attorney firm to file in the home attorney firm's home country. In addition, identifying the actual applicants for which an attorney firm has filed IP applications in their home country is not indicative of the ability or likelihood of those applicants requiring IP applications to be filed in the home attorney's home country. Thus, none of these provide a structured, informed or empirical process for the home attorney firm to identify the attorney firms in other countries that are good prospects for reciprocity.

### DISCLOSURE OF THE INVENTION

In accordance with a first aspect of the present invention, there is provided a server connectable to a data communications network comprising a database containing records of destination IP applications and records of source IP applications, each destination IP application being associated with a source IP application, each record identifying the party that filed the IP application and the jurisdiction in which the IP application was filed, a data set generation module to generate an IP application exchange data set for a given party in relation to a jurisdiction, the exchange data set containing a first list of parties that have filed at least one destination IP application in the jurisdiction for which the associated source IP application was filed by the given party, a second list of parties that have filed at least one source IP application in the jurisdiction for which an associated destination IP application was filed by the given party, wherein the data set generation module is adapted to produce the total number of IP applications filed by each party in said first and second lists; and an output module to send the case exchange data set to a recipient using the data communications network.

Preferably, the server further comprising a compilation module to create a consolidated list containing the first list of parties and the second list of parties, wherein for each party in the consolidated list, the consolidated list includes a sent total equalling the total number of IP applications associated with that party from the first list, and a received total equalling the total number of IP applications associated with that party from the second list.

Preferably, at least one record includes the date that the IP application was filed, and the server further comprising a time limitation module to permit selection of the time period to which the exchange data set relates based on the date that the IP application was filed.

Preferably, the server further comprising a visual representation generation module to generate a visual comparison of the sent total and received total for each party in the consolidated list.

Preferably, the visual comparison is in the form of a graph, selected from the group consisting of: a bar graph and a column graph.

In accordance with a second aspect of the present invention, there is provided a process for producing an IP application exchange data set for a given party in relation to a jurisdiction comprising the steps of accessing a database containing records of destination IP applications and records of source IP applications, each destination IP application being associated with a source IP application, each record identifying the party that filed the IP application and the jurisdiction in which the IP application was filed, generating a first list of parties that have filed at least one destination IP application in the jurisdiction for which the associated source IP application was filed by the given party, generating a second list of parties that have filed at least one source IP application in the jurisdiction for which an associated destination IP application was filed by the given party, and calculating the total number of IP applications filed by each party in said first and second lists.

Preferably, the process further comprising the step of creating a consolidated list containing the first list of parties and the second list of parties, wherein for each party in the consolidated list, the consolidated list includes a sent total equalling the total number of IP applications associated with that party from the first list, and a received total equalling the total number of IP applications associated with that party from the second list.

Preferably, the process further comprising the step of accessing the database to retrieve the dates that the IP applications were filed, and limiting the time period to which the IP application exchange data set relates based on the date that the IP applications were filed.

Preferably, the process further comprising the step of generating a visual comparison of the sent total and received total for each party in the consolidated list.

Preferably, generating a visual comparison of the sent total and received total for each party in the consolidated list comprises generating a visual comparison in the form of a graph selected from the group consisting of: a bar graph and a column graph.

### BRIEF DESCRIPTION OF THE DRAWINGS

The present invention will now be described, by way of example only, with reference to the accompanying drawings, in which:

FIG. 1 is a flow chart illustrating an embodiment of the process for producing an IP application exchange data set for a given party in relation to a jurisdiction in accordance with an aspect of the present invention;

FIG. 2 is a schematic diagram illustrating an embodiment of a server, in accordance with another aspect of the present invention, connected to a data communications network;

FIG. 3 is an entity-relationship diagram illustrating a database table structure used in an embodiment of the present invention;

FIG. 4 is an graphical representation of an IP application case exchange data set produced by an embodiment of the present invention;

FIG. 5a represents an example sent list and received list produced by the data set generation module of an embodiment of a system in accordance with an aspect of the present invention;

FIG. 5b represents an example consolidated list produced by the compilation module of an embodiment of the present invention; and

FIG. 6 represents a column graph table produced by the visual representation generation module of an embodiment of the present invention.

### BEST MODE(S) FOR CARRYING OUT THE INVENTION

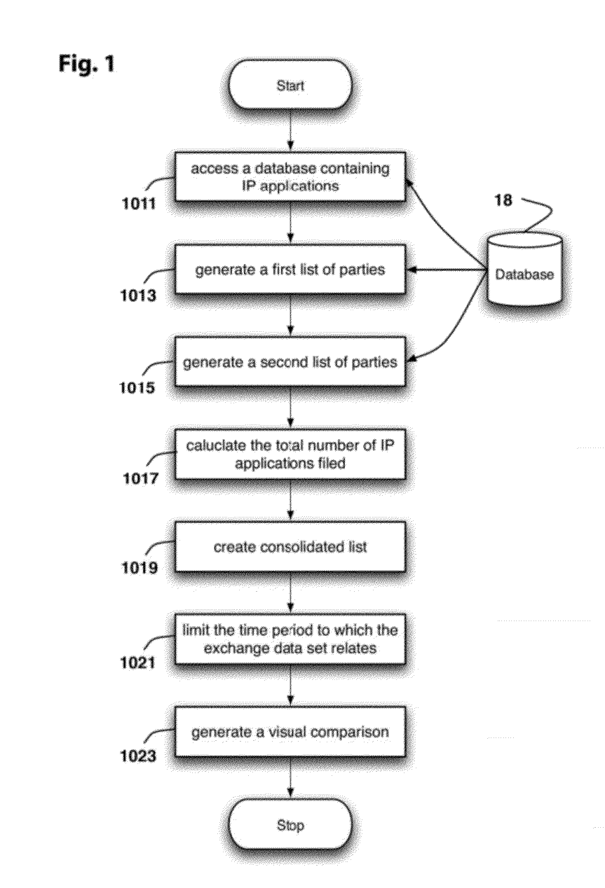

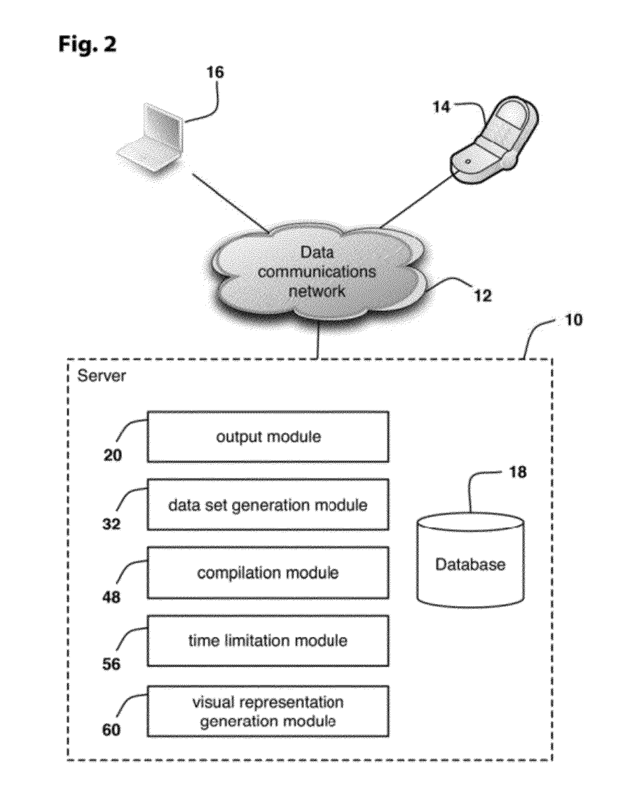

An embodiment of the present invention will now be described with reference to FIGS. 1 to 6 of the drawings.

In FIG. 1, there is shown a server 10 that is connectable to a data communications network 12. The data communications network 12 may be a public network such as the Internet, or a private network, for example, a company intranet. It is a network used to provide a communications link between a server and various devices and computers connected together on the data communications network 12. This may include clients via a mobile ‘smart phone’ device 14, or a client computer 16 such as a desktop or laptop computer.

The server 10 comprises a database 18. The database 18 may ideally utilise a relational database technology, such as a commercial database technology provided by companies such as Oracle™ or Microsoft™.

The server 10 may be one or more computers connected together via a communications link. The server 10 further comprises an output module 20, which may take the form of a web application server such as Sun™ Glassfish server. An alternative output module 20 may also be employed, as will be known to those skilled in the art. The database 18 and the output module 20 may be on a single computer, or may be deployed on several computers.

The output module 20 may be accessed via a mobile ‘smart phone’ device 14, or a client computer 16, using a web browser. There are several technologies by which an output module 20 may communicate with a user. The mobile ‘smart phone’ device 14, or a client computer 16, using a web browser are provided as but two examples of how an output module 20 may be accessed.

The database 18 contains records of IP applications. The records of the IP applications in the database 18 are records of destination IP applications 22 and records of source IP applications 24. Each destination IP application 22 is associated with a source IP application 24.

In the preferred embodiment of the invention described herein, the IP applications are patent applications. The destination IP applications 22 may take the form of a Patent Cooperation Treaty (‘PCT’) national phase patent application, or a patent application filed via the Paris Convention. In a case where a destination IP application 22 is a PCT national phase patent application, the associated source IP application 24 may be the PCT application itself. In a case where a destination IP application 22 is a patent application filed via the Paris Convention, the associated source IP application 24 may be the patent application from which Convention priority was claimed.

Each record in the database 18 identifies the party that filed the IP application 26, i.e. the IP application filing party 26, and the IP application filing jurisdiction 28 in which the IP application was filed. Preferably, the application number 30 of the IP application, as well as the filing date 58 of the IP application are also stored in the record of each IP application in the database 18. The IP application records as referred to in this paragraph can be either a destination IP application record 22 or a source IP application record 24.

The records of the IP applications in the database 18 may encompass IP applications filed in many IP application filing jurisdictions 28. For the present invention to be used, the database 18 must contain records of IP applications from at least two IP application filing jurisdictions 28. Accordingly, the description of the preferred embodiment will be with reference to the database containing records of IP applications from two IP application filing jurisdictions 28. However, records of IP applications filed in other IP application filing jurisdictions 28 can also be stored in the database 18.

As the description of the preferred embodiment herein will be with reference to the IP applications being patent applications, i.e. the type of IP is a patent, the destination IP application records 22 are also referred to herein as destination patent application records 22 and the source IP application records 24 are also referred to herein as source patent application records 24.

At least two data sources may be utilised to create the records of the destination patent applications 22 that are contained in the database 18. The two data sources, for example, may be loaded into a temporary storage space such as a computers memory or they may be stored in the database 18 in a temporary table.

For the purposes of the description of the preferred embodiment, the two filing jurisdictions 28 that will be used are the USA and Europe.

To provide a specific example of two data sources that may be utilised, a first data source may be the United States Patent and Trademark Office (“USPTO”) Patent Application Bibliographic Data XML information, which can be downloaded from their Sales Order Management System under the Patent Data category. The second data source may be the European Patent Office (“EPO”) European Patent Bulletin, which is available from the European Publication Server. This can be purchased and downloaded in various formats including machine-readable PDF or XML files.

Each patent application in the USPTO patent data source may be optimally loaded into a temporary storage space. Each patent application in the EPO patent data source may also loaded into a temporary storage space.

To create the records of the IP applications in the database 18, a process may iterate through each patent application record in the USPTO patent data source to indentify the patent applications that include a priority claim from a European patent application. For each patent application identified, a destination IP application record 22 is saved to the database 18 if it does not exist already in the database 18. The destination IP application record 22 should include the party that filed the application 26 (for example, an attorney/law firm), the IP filing jurisdiction 28 (i.e. the USA) and a patent application number 30. It may also include the filing date 58 of the patent application.

When the destination IP application records 22 are created, the process also checks whether a corresponding source IP application record 24, for each destination IP application record 22, exists in the database 18. Each source IP application 22 can be identified by the application number 30 of the source IP application record (in this case, the priority European patent application) of the destination IP application record 24. The source IP application records 22 may include the filing date 58 of the application. Each destination IP application record 22 is associated with its corresponding source IP application record 24.

As an example, in a case where a destination IP application 22 was a US application, the IP filing jurisdiction 28 would be the USA. In this example, the source IP application record 24 would include the IP filing jurisdiction 28 of the EPO using the two letter code EP, and the record would also include the application number 30, and may include the date that the application was filed 58.

A similar process may be carried out using the EPO patent data source, except that the process would extract European patent applications, which would be identified as destination IP applications 22 in the database 18, for which priority is claimed from US applications. In this case, those US applications would be the source IP applications 24.

Once the records of the destination IP applications 22 and source IP applications 24 are stored in the database 18, there may be source IP application records 24 that do not yet include the party that filed the application 26. To obtain this information, a process may iterate through each source IP application record 24 identified as having an IP filing jurisdiction of EP, and for each identified record, locate that application number 30 in the EPO patent data source, which will in turn include the party that filed the application 26. The party that filed the application 26 is then stored in the corresponding source IP application record 24 in the database 18.

A similar process can be used to identify the party that filed each source IP application 24 identified as having an IP filing jurisdiction 28 of the USA, using the USPTO patent data source. Once again, the party that filed the application 26 is stored in the corresponding source IP application record 24 in the database 18.

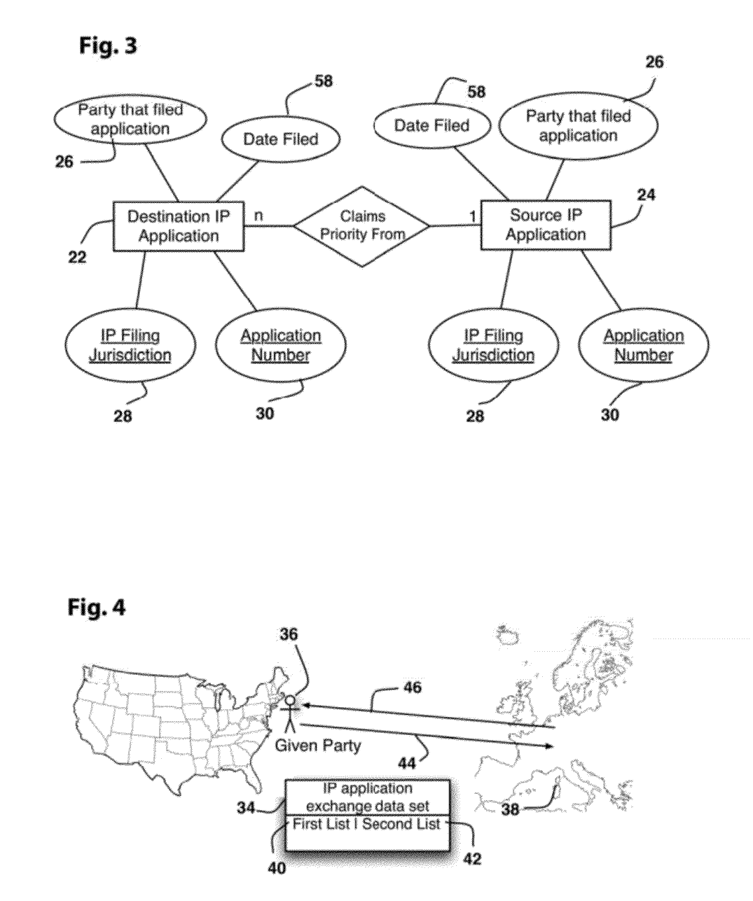

An entity-relationship diagram is shown in FIG. 3, to illustrate how the records of the destination IP applications 22 and the source IP applications 24 may be stored in the database 18. As will be appreciated by a person skilled in the art, the exact form of the database tables in the database 18 may vary, and is not an essential element to the implementation of the present invention. For example, the destination IP application records 22 and source IP application records 24 could be stored in a single table, with a field identifying whether the IP application is a source IP application record 24 or a destination IP application record 22.

The process for producing an IP application exchange data set for a given party in relation to a jurisdiction will now be described with particular reference to FIG. 1.

The process starts by accessing the database 18 containing the IP applications at 1011.

The server 10 further comprises a data set generation module 32 to generate an IP application exchange data set 34 for a given party 36 in relation to a jurisdiction 38. The given party 36 may, for example, be an individual, a company or an attorney/law firm. The jurisdiction 38 may, for example, be a region, i.e. a group of countries, or an individual country, e.g. the USA, Japan or Germany. An example of a region is Europe.

The server 10 may further comprise a time limitation module 56 to permit selection of the time period to which the exchange data set 34 relates based on the date that the IP application was filed 58, i.e. the filing date 58.

The data set generation module 32 generates a first list of parties 40 at 1013. The first list of parties 40 contains parties that have filed at least one destination IP application 22, in the jurisdiction 38, for which the associated source IP application 24 was filed by the given party 36. The first list of parties 40 is also referred to in this specification as a “sent list”. The sent list 40 is a list of the parties that have filed IP applications in the jurisdiction 38 on behalf of the given party 36. That is, the parties to which the given party 36 has sent IP applications to file in the jurisdiction 38.

Whether the destination IP application 22 or source IP application 24 was filed in the jurisdiction 38 can be determined in one of two ways. Firstly, it could be determined on the basis that the application filing jurisdiction 28 is the same as the jurisdiction 38. Alternatively, it could be determined on the basis that the party that filed the application 26 has an address located in the jurisdiction 38.

The data set generation module 32 generates a second list of parties 42 at 1015. The second list of parties 42 contains parties that have filed at least one source IP application 24 in the jurisdiction 38 for which an associated destination IP application 22 was filed by the given party 36. The second list of parties 42 is also referred to in this specification as a “received list” 42. The received list 42 is a list of the parties that have filed destination IP applications 22 using the given party 36, for which the source IP applications 24 were filed in the jurisdiction 38. That is, the parties from which the given party 36 has received IP applications, originating from the jurisdiction 38.

The parties in the sent list 40 or the received list 42 may include, for example, individuals, companies and/or an attorney/law firms.

The data set generation module 32 is adapted to produce the total number of IP applications filed by each party in the sent and received lists. The data set generation module 32 calculates the total at 1017. Calculating the total is achieved in the present embodiment by using the GROUP BY functionality provided by an SQL server.

An example usage of the data set generation module 32 is provided in FIG. 4. In this example, the jurisdiction 38 is Europe, and the given party 36 is an attorney/law firm based in the USA, which is identified herein as Firm XUSA 36. The line 44 originating from the given party 36 and directed to Europe symbolises the flow of IP applications represented by the sent list 40. The line 46 originating from Europe and directed to the given party 36 symbolises the flow of IP applications represented by the received list 42.

To continue with this example, the sent list of parties 40 is a list of parties that have filed at least one European destination IP application 22 where the source IP application 24 was filed by Firm XUSA 36.

To obtain the sent list of parties 40, an SQL command may be issued to the database 18, to the following effect SELECT COUNT(*), dest.party_that_filed_application

FROM Destination_IP_Apps dest WHERE dest.ip_filing_jurisdiction=‘EP’ AND where dest.source_ip_application.party_that_filed_application=‘Firm XUSA’ GROUP BY dest.party_that_filed_application.

To obtain the received list of parties 42, an SQL command may be issued to the database 18, to the following effect SELECT COUNT(*),dest.party_that_filed_application FROM Destination_IP_Apps dest WHERE dest.ip_filing_jurisdiction=‘EP’ AND where dest.party_that_filed_application=‘Firm XUSA’ and dest.source_ip_application ip_filing_jurisdiction=‘EP’ GROUP BY dest.party_that_filed_application.

A further limitation may be imposed, if selected, by the time limitation module 56, whereby the SQL query may include a restriction according to the filing date 58 of the IP application. For example, there may be an additional limitation in the WHERE clauses of dest.date_filed>=‘1 year ago’. The time limitation module 56 limits the time period to which the exchange data set 34 relates at 1021.

By using the GROUP BY clause coupled with the COUNT selection, the data set generation module 32 can produce the total number of IP applications filed by each party for the sent and received lists 40 and 42.

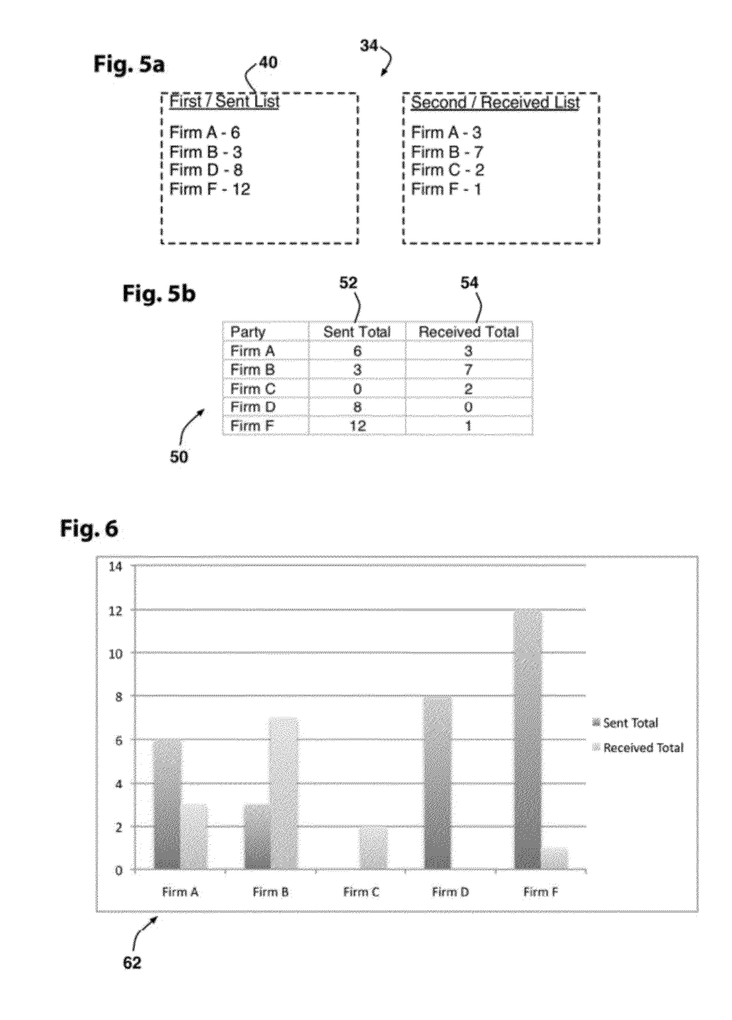

A sample output of the sent list of parties 40 and the received list of parties 42 is provided in FIG. 5a. The sent list of parties 40 shows that the given firm 36 Firm XUSA has ‘sent’ 6 IP applications to Firm A, and that Firm XUSA has ‘sent’ 3 cases to Firm B, and so forth. The received list of parties 42 shows that Firm XUSA has ‘received’ 3 cases from Firm A, and that Firm XUSA has ‘received’ 6 cases from Firm B, and so forth.

The server 10 also includes a compilation module 48, to create a consolidated list 50 containing the sent list of parties 40 and the received list of parties 42. The compilation module 48 creates the consolidated list at 1019.

The consolidated list 50 includes a sent total 52 equalling the total number of IP applications associated with, i.e. IP applications sent by, that party from the sent list 40, and a received total 54 equalling the total number of IP applications associated with, i.e. IP applications received from, that party from the received list 42. It should be noted that if a party does not appear on the sent list of parties 40, a zero value for sent total is adopted, as is the case for Firm C in the example. Similarly, if a party does not appear on the received list of parties 42, a zero value for received total is adopted, as is the case for Firm D in the example.

The server 10 may also include a visual representation generation module 60, to generate a visual comparison of the sent total 52 and received total 54 for each party in the consolidated list 50. The visual representation generation module 60 generates the visual comparison at 1023. The visual comparison may take the form of a bar graph or a column graph. An example column graph 62 is provided in FIG. 6, showing patent applications ‘sent’ and ‘received’ for Firm XUSA, in connection with the European jurisdiction 38.

Accordingly, the present invention enables the IP applications that a given party has sent and received with respect to a particular jurisdiction to be determined based on actual numbers of IP applications that have been filed by the given party directly, and by other parties in a particular jurisdiction on behalf of the given party. Furthermore, the present invention provides a mechanism by which the IP application exchange data can be readily ascertained, provided and understood.

Modifications and variations such as would be apparent to a skilled addressee are deemed to be within the scope of the present invention.

I claim:

1. A server connectable to a data communications network comprising:
a database containing records of destination IP applications and records of source IP applications,
each destination IP application being associated with a source IP application,
each record identifying the party that filed the IP application and the jurisdiction in which the IP application was filed,
a data set generation module to generate an IP application exchange data set for a given party in relation to a jurisdiction, the exchange data set containing
a first list of parties that have filed at least one destination IP application in the jurisdiction for which the associated source IP application was filed by the given party,
a second list of parties that have filed at least one source IP application in the jurisdiction for which an associated destination IP application was filed by the given party,
wherein the data set generation module is adapted to produce the total number of IP applications filed by each party in said first and second lists; and
an output module to send the case exchange data set to a recipient using the data communications network.

2. A server according to claim 1, the server further comprising a compilation module to create a consolidated list containing the first list of parties and the second list of parties, wherein for each party in the consolidated list, the consolidated list includes a sent total equalling the total number of IP applications associated with that party from the first list, and a received total equalling the total number of IP applications associated with that party from the second list.

3. A server according to claim 1, wherein at least one record includes the date that the IP application was filed, and the server further comprising a time limitation module to permit selection of the time period to which the exchange data set relates based on the date that the IP application was filed.

4. A server according to claim 2, the server further comprising a visual representation generation module to generate a visual comparison of the sent total and received total for each party in the consolidated list.

5. A server according to claim 4, where the visual comparison is in the form of a graph, selected from the group consisting of: a bar graph and a column graph.

6. A process for producing an IP application exchange data set for a given party in relation to a jurisdiction comprising the steps of
accessing a database containing records of destination IP applications and records of source IP applications,
each destination IP application being associated with a source IP application,
each record identifying the party that filed the IP application and the jurisdiction in which the IP application was filed,
generating a first list of parties that have filed at least one destination IP application in the jurisdiction for which the associated source IP application was filed by the given party,
generating a second list of parties that have filed at least one source IP application in the jurisdiction for which an associated destination IP application was filed by the given party, and
calculating the total number of IP applications filed by each party in said first and second lists.

7. A process according to claim 6, further comprising the step of creating a consolidated list containing the first list of parties and the second list of parties, wherein for each party in the consolidated list, the consolidated list includes a sent total equalling the total number of IP applications associated with that party from the first list, and a received total equalling the total number of IP applications associated with that party from the second list.

8. A process according claim 6, further comprising the step of accessing the database to retrieve the dates that the IP applications were filed, and limiting the time period to which the IP application exchange data set relates based on the date that the IP applications were filed.

9. A process according to claim 7, further comprising the step of generating a visual comparison of the sent total and received total for each party in the consolidated list.

10. A process according to claim 9, wherein generating a visual comparison of the sent total and received total for each party in the consolidated list comprises generating a visual comparison in the form of a graph selected from the group consisting of: a bar graph and a column graph.
